(19) United States
(12) Patent Application Publication
(10) Pub. No.: US 2012/0295787 A1
(43) Pub. Date: Nov. 22, 2012

(54) EXHAUST GAS PURIFYING CATALYST

(76) Inventors: Hanae Ikeda, Toyota-shi (JP); Takaaki Kanazawa, Toyota-shi (JP)

(21) Appl. No.: 13/574,257

(22) PCT Filed: Jan. 18, 2011
(86) PCT No.: PCT/IB2011/000064

§ 371 Date: Jul. 20, 2012

(30) Foreign Application Priority Data
Jan. 22, 2010 (JP) 2010-012247

(51) Int. Cl. B01J 23/63

(52) U.S. Cl. 502/304

(57) ABSTRACT

An exhaust gas purifying catalyst includes a catalyst powder that includes a ceria-zirconia composite oxide on which platinum (Pt) is supported, and a Ce/alumina powder that includes alumina which contains cerium (Ce) in the structure thereof. The Ce/alumina undergoes only a slight decrease in specific surface area even in a lean atmosphere at a high temperature. The Pt supported on the ceria-zirconia composite oxide forms a Pt—O—Ce bond with the Ce present on surfaces of Ce/alumina so that migration of Pt is restrained and sintering of Pt is prevented.

### BACKGROUND OF THE INVENTION

1. Field of the Invention

The present invention relates to an exhaust gas purifying catalyst that purifies exhaust gas discharged from internal combustion engines, and, more specifically, to a method of improving the durability of the exhaust gas purifying catalyst.

2. Description of the Related Art

Three-way catalysts are conventionally and widely used as exhaust gas purifying catalysts in purifying exhaust gas of automobiles. A three-way catalyst is composed of a porous carrier, such as γ-alumina (Al₂O₃), and a precious metal, such as platinum (Pt) or rhodium (Rh), that is supported on the carrier. The threeway catalyst can efficiently purify carbon monoxide (CO), hydrocarbons (HC) and nitrogen oxides (NO_{R}) when the air-fuel ratio is close to the theoretical air-fuel ratio. One reason for using γ-alumina as a carrier is that the bonding strength between a coating layer and a honeycomb substrate is improved by increasing the specific surface area. Also, γ-alumina is known that is stabilized by the addition of lanthanum (La) so that the large specific surface area can be maintained even after operation at high temperatures for an extended period of timer.

In recent years, ceria, a ceria-zirconia composite oxide, or the like is generally used as a component of the carrier to suppress fluctuations in air-fuel ratio. Because ceria absorbs or adsorbs oxygen when exposed to a lean atmosphere and releases oxygen when exposed to a rich atmosphere, the air-fuel ratio of the exhaust gas atmosphere may be stably maintained near the stoichiometric value when ceria, a ceria-zirconia composite oxide, or the like is used in the carrier.

Precious metals, such as Pt and palladium (Pd), primarily catalyzes the oxidation of CO and HC, and Rh primarily catalyzes the reduction of NO_{R}. It is, therefore, known that Pt or Pd, and Rh are preferably used together in a three-way catalyst. However, it has been found that when Pt and Rh, or Pd and Rh are used together, Rh tends to form an alloy with Pt or Pd at high temperatures so that the oxidation activity of Pt or Pd and the reduction activity of Rh are reduced. In addition, there are some unfavorable combinations of a precious metal species and a species of carrier, depending on use conditions. For example, in a catalyst that is composed of alumina on which Rh is supported, Rh is solid-dissolved in alumina in an oxidizing atmosphere if the temperature should reach or exceed of 900° C. As a result, the performance of the catalyst significantly decreases.

Furthermore, three-way catalysts are strongly required to have high durability at a high temperature of 900° C. or higher. To satisfy the requirement, suppressing the deterioration of the catalyst is an important issue to be resolved. Also, because Rh is a very rare resource, efficient use of Rh as well as prevention of deterioration of Rh by improving the thermal resistance thereof are desirable.

Thus, a catalyst that has a coat layer with a double-layer structure has been proposed so that a plurality of precious metals can be separately supported. For example, Japanese Patent Application Publication No. 06-063403 (JP-A-06-063403) describes a catalyst that includes a first coat layer that contains Pt or Pd and a second coat layer that is provided over the first coat layer and contains Rh with an oxide powder that is composed primarily of ceria (CeO₂) and zirconia (ZrO₂).

However, even in a catalyst in which Pt and Rh segregated in lower and upper layers, Pt particles and Rh particles may migrate between the lower and upper layers at high temperatures. Consequently, Pt and Rh may become solid-dissolved in each other so that the effect attained by separately supporting Pt and Rh deteriorates. In this circumstance, Japanese Patent Application Publication No. 2004-298813 (JP-A-2004-298813) describes a three-way catalyst that includes a lower catalyst layer that is composed of a mixture of alumina on which Pt is supported and a ceria-zirconia composite oxide (ceria occupies 50% by weight or more), and an upper catalyst layer that is composed of ceria-zirconia composite oxide which has characteristic that heat deterioration thereof is low (ceria occupies approximately 30% by weight) on which Rh is supported.

When Rh and Pt, or Rh and Pd are separately contained in different layers as described above, CO, HC and NOₓ may be purified efficiently, and a decrease in the oxidation ability of Pt or Pd and in the reduction ability of Rh due to alloying can be suppressed.

However, in an oxidizing atmosphere at a high temperature of 900 to 1,000° C., a decrease in a specific surface area is inevitable even if γ- or θ-alumina that is stabilized by lanthanum is used as a carrier. As a result, the supported precious metal, such as Pt, undergoes sintering (grain growth) to cause a reduction of active sites, thereby resulting in decreased purification activity after operation at high temperatures for an extended period of time, that is an internal combustion engine has been operated under a high load for an extended period of time.

### SUMMARY OF THE INVENTION

The present invention provides a large specific surface area even after operation at high-temperatures at 1000° C. or higher and in which sintering of Pt or the like is reduced, thereby improving durability.

A feature of the exhaust gas purifying catalyst of the present invention that solves the above problem is that the exhaust gas purifying catalyst includes a catalyst powder that comprises a ceria-zirconia composite oxide on which at least one of platinum and palladium is supported, and a Ce/alumina powder that includes alumina in which cerium (Ce) is incorporated into the crystalline structure thereof.

Also, in the exhaust gas purifying catalyst, concentration of the cerium as metallic Ce in the alumina of the Ce/alumina powder is 5 to 10% by mass.

Although details of the reason have not fully clarified, the Ce/alumina that is composed of cerium-containing alumina undergoes only a slight decrease in specific surface area even in a lean atmosphere at a high temperature. Also, it is believed that the Pt, for example, that is supported on the ceria-zirconia composite oxide forms a Pt—O—Ce bond with the Ce that is present in a fine form on surfaces of the cerium-containing Ce/alumina. Thus, migration of Pt is restrained and sintering of Pt is prevented.

Therefore, according to the exhaust gas purifying catalyst of the present invention, because the Ce/alumina, that contains cerium has a large specific surface area even after operation at high-temperatures for an extended period of time, separation of a coat layer from a honeycomb substrate can be prevented. Also, because sintering of the precious metal, such as Pt, that is supported on the ceria-zirconia composite oxide is restricted, the durability of the catalytic activity is improved and the oxygen adsorption/desorption ability after an extended period of operation.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is schematic view of an exhaust gas purifying catalyst according to Example 1;

FIG. 2 is a graph that shows the relationship between the Ce concentration and the specific surface area of the catalysts according to Examples 1 to 4 and Comparative Example 1;

FIG. 3 is a graph that shows the relationship between the Ce concentration and the 50% HC purification temperature of the catalysts according to Examples 1 to 4 and Comparative Example 1;

FIG. 4 is a graph that shows the relationship between the Ce concentration and 50% HC purification temperature after endurance testing of the catalyst according to Comparative Example 2;

FIG. 5 is a graph that shows the relationship between the Ce concentration and Pt particle size after endurance testing of the catalysts according to Examples 3 and 4 and Comparative Example 1; and

FIG. 6 is a graph that shows the oxygen storage capacities after endurance testing of the honeycomb catalysts according to Examples 5 and 6 and Comparative Examples 3 to 5.

### DETAILED DESCRIPTION OF EMBODIMENTS

An exhaust gas purifying catalyst of the present invention comprises a catalyst powder that includes a ceria-zirconia composite oxide on which at least one of platinum and palladium is supported, and a Ce/alumina powder that comprises alumina which contains cerium in the structure thereof (Note: the term “ceria” is used to refer to cerium oxide (CeO₂), and the term “zirconia” is used to refers to zirconium oxide (ZrO₂)).

As the alumina of the Ce/alumina powder, γ-phase alumina is most preferred but δ-, θ- or α-phase alumina can also be used. If γ-phase alumina (γ-alumina) is used, it is transformed into δ- or θ-phase alumina after a high-temperature endurance test.

The cerium in the Ce/alumina powder is not simply mixed with the alumina but is actually incorporated in the crystalline structure of the alumina with a high degree of dispersion. The concentration of cerium in the alumina is preferably in the range of 5 to 10% by mass as metallic Ce. A cerium concentration below 5% by mass does not produce a sufficient effect that is expected from the use of cerium, and a cerium concentration exceeding 10% by mass tends to result in the generation of an independent CeO₂ phase, which decreases in the specific surface area after operation at high temperatures for an extended period of time. To incorporate cerium into the crystalline structure of the alumina with a high degree of dispersion, a method in which an oxide precursor is prepared by an alkoxide method, a coprecipitation method, or the like method and calcining the oxide precursor is preferable.

The catalyst powder includes a ceria-zirconia composite oxide on which at least one of Pt and Pd is supported. The molar ratio between Ce and Zr in the ceria-zirconia composite oxide is preferably in the range of 1:4 to 4:1 that is expressed in terms of metal. If the proportion of Ce is below this range, the oxygen adsorption/desorption ability decreases and the carrier itself tends to undergo sintering, resulting in poor purification performance. If the ratio of Zr is below this range, the stability of the ceria-zirconia composite oxide decreases and the durability of the catalyst decreases accordingly.

The amount of at least one of Pt and Pd that is supported may be the same as that in conventional catalysts. Also, the ratio of the catalyst powder to the Ce/alumina powder that includes a cerium-containing alumina is not specifically limited. However, if the amount of the catalyst powder is excessively small, the oxygen adsorption/desorption may be insufficient. In addition, if the amount of Ce/alumina powder is excessively small, the precious metal is more likely to undergo sintering.

The exhaust gas purifying catalyst according to the present invention may be used by itself as an exhaust gas purifying catalyst such as an oxidation catalyst. However, it is preferable to use the catalyst be as a three-way catalyst for reducing NOₓ. For example, a honeycomb substrate may be coated with the exhaust gas purifying catalyst of the present invention to form a lower catalyst layer and an upper catalyst layer that contains Rh is formed over the lower catalyst layer. When Rh and Pt, or Rh and Pd are contained in separate layers as described above, CO, HC and NO may be efficiently purified, and a decrease in the oxidation ability of the Pt or Pd and in the reduction ability of Rh due to alloying may be avoided.

The carrier for the upper catalyst layer containing Rh preferably contains at least zirconia. Accordingly, H₂ is generated through a water gas shift reaction or steam reforming reaction, and thereby further increases the NOₓ reduction activity. The thicknesses of the lower catalyst layer and the upper catalyst layer are not specifically limited, but the upper catalyst layer preferably has a thickness of 80 μm or less, and the ratio in thickness of the lower catalyst layer to the upper catalyst layer (lower catalyst layer:upper catalyst layer) is in the range of 2:1 to 4:1 because the lower catalyst layer cannot be used effectively if the upper catalyst layer is excessively thick.

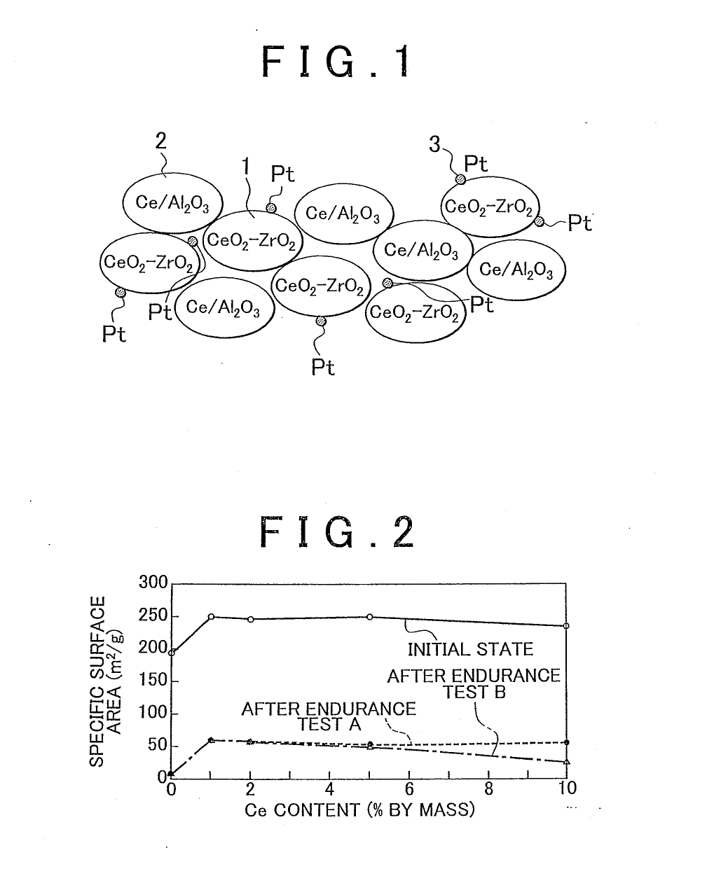

The following Examples and Comparative. Examples describe the present invention in detail. First, Example 1 will be described. FIG. 1 schematically illustrates an exhaust gas purifying catalyst according to this example. The exhaust gas purifying catalyst is composed of a mixture of a CeO₂—ZrO₂ powder that consists of CeO₂—ZrO₂ particles 1 and a Ce/alumina powder that consists of Ce-containing γ-phase Al₂O₃ particles 2, and Pt 3 that is supported on the CeO₂—ZrO₂ particles 1. A method of producing the exhaust gas purifying catalyst is described below instead of providing a detail description of the structure thereof.

Aluminum isopropoxide was hydrolyzed by adding the aluminum isopropozide to distilled water heated to 80° C. Nitric acid was then added to the mixture, and the mixture was stirred for 30 minutes to disperse an alumina precursor.

A cerium nitrate solution in ethylene glycol was prepared and added to the above alumina precursor dispersion liquid, and the mixture was stirred for 12 hours. The resulting mixture was evaporated to dryness at 80° C. in an evaporator and then dried at 120° C. in a vacuum dryer. The dried product was then calcined at 600° C. for 2 hours, thereby preparing a Ce(1)/Al₂O₃ powder composed of γ-alumina that contained 1% by mass of cerium as metallic Ce.

Next, a ceria-zirconia composite oxide powder (CeO₂: 30% by mass, ZrO₂: 60% by mass, lanthana (La₂O₃): 5% by mass, and yttria (Y₂O₃): 5% by mass) was provided, into which a dinitrodiammine platinum solution of specified concentration was impregnated. The impregnated powder was then dried at 120° C. and calcined at 600° C., thereby preparing a Pt/CeO₂—ZrO₂ powder which is composed of CeO₂—ZrO₂ on which Pt was supported. The concentration of Pt supported is 0.4% by mass.

The Ce(1)/Al₂O₃ powder and the Pt/ZrO₂—CeO₂ powder that are prepared were mixed at a mass ratio of 1:1, and the mixture was formed into pellets using a conventional method, thereby preparing a pellet catalyst of this example. The concentration of Pt supported is 0.2% by mass.

A Ce(2)/Al₂O₃ powder composed of γ-alumina containing 2% by mass of cerium as metallic Ce was prepared in the same manner as described in Example 1, except that the cerium nitrate concentration in the ethylene glycol solution was different. A pellet catalyst according to this example is prepared in the same manner as described in Example 1, except that the Ce(2)/Al₂O₃ powder is used instead of the Ce(1)/Al₂O₃ powder. The concentration of Pt supported is the same as that in Example 1.

A Ce(5)/Al₂O₃ powder composed of γ-alumina containing 5% by mass of cerium as metallic Ce was prepared in the same manner as described in Example 1 except that the cerium nitrate concentration in the ethylene glycol solution is different. A pellet catalyst according to this example was prepared in the same manner as described in Example 1, except that the Ce(5)/Al₂O₃ powder is used instead of the Ce(1)/Al₂O₃ powder. The concentration of Pt supported is the same as that in Example 1.

A Ce(10)/Al₂O₃ powder composed of γ-alumina that contained 10% by mass of cerium as metallic Ce was prepared in the same manner as described in Example 1 except that the ethylene glycol solution had a different concentration of cerium nitrate. A pellet catalyst of this example was prepared in the same manner as in Example 1 except that the Ce(10)/Al₂O₃ powder was used instead of the Ce(1)/Al₂O₃ powder. The concentration of Pt supported is the same as that in Example 1.

In Comparative Example 1, the solution of cerium nitrate in ethylene glycol was not used, and only the same alumina precursor dispersion liquid, as used in Example 1, was evaporated to dryness at 80° C., dried at 120° C. in a vacuum dryer, and calcined at 600° C. for 2 hours to prepare an Al₂O₃ powder composed of γ-alumina that did not contain Ce. The pellet catalyst of this example is prepared in the same manner as in Example 1 except that the above Al₂O₃ powder is used instead of the Ce(1)/Al₂O₃ powder. The concentration of Pt supported is the same as that in Example 1.

Test Example regarding the specific surface area is described next. The pellet catalysts prepared in Examples 1 to 4 and Comparative Example 1 were each measured by the BET method for the initial specific surface area, the specific surface area after an endurance test A in which a sample was heated at 1,100° C. for 5 hours in the atmosphere. The specific surface area after an endurance test B in which a sample was heated at 1,100° C. for 5 hours under an atmosphere into which a nitrogen (N₂) gas that contained 2% of CO and another N₂ gas that contained 5% of O₂ were introduced alternately every 2 minutes. The results are shown in FIG. 2.

From FIG. 2 it is apparent that the initial specific surface area and the specific surface areas after the endurance tests A and B of the catalyst of each Example were greater than those of the catalyst of Comparative Example 1, respectively. That is, it is when γ-alumina contains cerium, the specific surface area increases and the same relation is maintained even after endurance testing. However, after the endurance test B in which samples were alternately exposed to rich and lean flows, the specific surface area tended to decrease with increasing Ce concentration. This is believed to be due to generation of an independent CeO₂ phase. Thus, the concentration of Ce in the Ce/alumina preferable does not exceed 10% by mass.

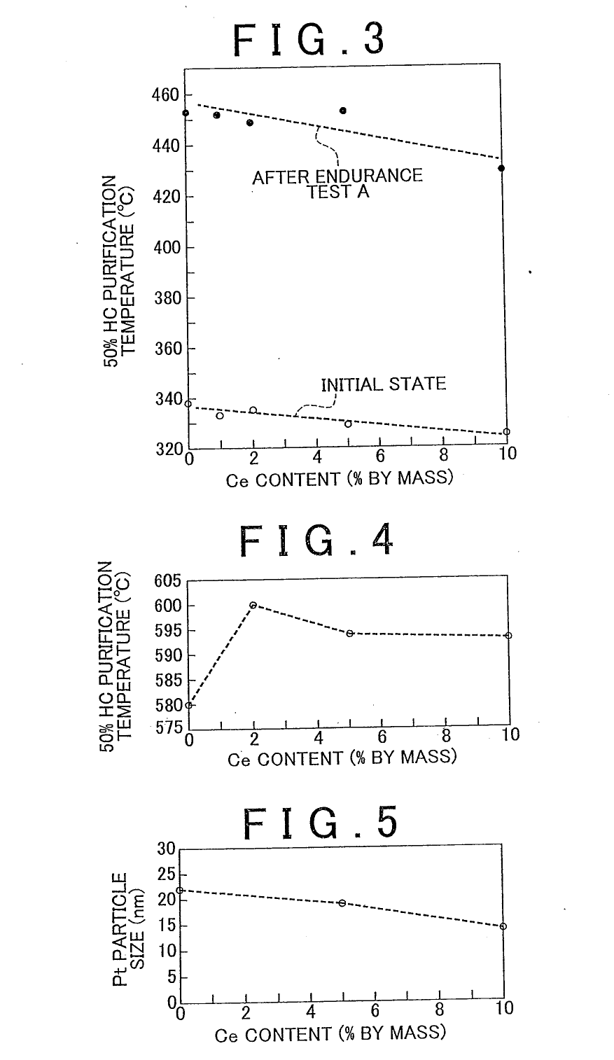

Test Example regarding the HC purification characteristics is described next. The pellet catalysts from each of Examples 1 to 4 and Comparative Example 1 in the initial state were charged in a testing device in an amount of 1.0 g respectively, and the C₃H₆ purification efficiency was measured while the test gas shown in Table 1 was introduced at a rate of 10 L/min and the inlet gas temperature was increased from 100° C. to 500° C. at a rate of 5° C./min. Then, the 50% C₃H₆ purification temperature was determined and plotted on a graph with Ce concentration along the horizontal axis. The results are shown in FIG. 3.

Also, the same endurance test A as in Test Example regarding the specific surface area described above is conducted on the pellet catalysts of Example 1 to 4 and Comparative Example 1, and the 50% purification temperature of each pellet catalyst after the endurance test A was measured in the same manner as described above. The results are also shown in FIG. 3.

TABLE 1

| | GAS SPECIES | | | | | | |
|---|---|---|---|---|---|---|---|
| | HC | NO | CO | CO₂ | O₂ | H₂O | N₂ |
| CON- | 2400 | 2400 ppm | 1200 PPM | 14% | 0.4% | 3% | BAL- |
| CEN- | ppm | | | | | | ANCE |
| TRATION | | | | | | | |

It is evident from FIG. 3 that the HC purification performance improved with increasing Ce concentration in the Ce/alumina both in the initial state and after the endurance test. The degree of the decrease in the 50% HC purification temperature is small within the range where the Ce content is low, but the 50% HC purification temperature may be decreased by 10° C. or more in comparison with Comparative Example 1 if the concentration of Ce is at least 5% by mass. Thus, the Ce concentration in the Ce/alumina is preferably at least 5% by mass.

Comparative Example 2 is described next. A Rh/CeO₂—ZrO₂ powder composed of CeO₂—ZrO₂ on which Rh is supported is prepared in the same manner as described in Example 1, except that a rhodium nitrate aqueous solution is used instead of the dinitrodiammine platinum solution. Pellet catalysts are prepared in the same manner as described in Examples 2 to 4 and Comparative Example 1, respectively, except that the Rh/CeO₂—ZrO₂ powder is used instead of the Pt/CeO₂—ZrO₂ powder. Then, 50% C₃H₆ purification temperature after the endurance test A of each pellet catalyst was measured in the same manner as described in “Test Example regarding HC purification characteristics.” The results are shown in FIG. 4.

From FIG. 4 it is appreciated that the HC purification performance does not improve even if a Ce/alumina powder composed of Ce-containing γ-alumina is used when Rh is supported instead of Pt. In other words, the effect of the present invention is specific to when a CeO₂—ZrO₂ powder is mixed with a CeO₂—ZrO₂ powder on which at least one of Pt and Pd is supported.

Test Example regarding sintering of Pt is described next. The Pt particle size of each of the pellet catalysts of Examples 3 and 4 and Comparative Example 1 is measured after the respective pellet catalysts are subjected to endurance test A. The results are shown in FIG. 5. While the Pt particle size was primarily measured by observation under a transmission electron microscope, measurements using CO adsorption and X-ray diffraction were also carried out and the measured values were averaged.

From FIG. 5 it is apparent that when a Ce/alumina powder composed of Ce-containing γ-alumina is used, sintering of Pt is restricted and the sintering restriction effect increases with increases in Ce concentration. That is, the improvements in performance of the pellet catalyst of each Example in “Test Example regarding HC purification characteristics” are believed to be due to the reduction of Pt sintering.

A Ce(4)/Al₂O₃ powder composed of γ-alumina containing 4% by mass of cerium as metallic Ce was prepared in the same manner as in Example 1, except that the ethylene glycol solution had a different concentration of cerium nitrate.

Also, a Pt/CeO₂—ZrO₂ powder composed of CeO₂—ZrO₂, on which a specified amount of Pt is supported, is prepared in the same manner as described in Example 1. In addition, an Rh/CeO₂—ZrO₂ powder composed of CeO₂—ZrO₂ on which a specified amount of Rh is supported, is prepared in the same manner as described in Comparative Example 2.

Next, the Ce(4)/Al₂O₃ powder and the Pt/CeO₂—ZrO₂ powder were mixed so that the resulting mixture contained 40 g/L of the Ce(4)/Al₂O₃ powder and 120 g/L of the Pt/CeO₂—ZrO₂ powder, to which an alumina sol binder and distilled water were also admixed to prepare a slurry for the lower layer.

In addition, an Al₂O₃ powder that was composed of γ-alumina that did not contain Ce, which was the same Al₂O₃ powder as described in Comparative Example 1, and the Rh/CeO₂—ZrO₂ powder were mixed so that the resulting mixture contained 25 g/L of the Al₂O₃ powder and 60 g/L of the Rh/CeO₂—ZrO₂ powder, to which an alumina sol binder and distilled water were also admixed to prepare a slurry for the upper layer.

A cordierite monolith honeycomb substrate is provided. The honeycomb substrate is washcoated with the slurry for a lower layer, and was dried and calcined to form a lower catalyst layer. The honeycomb substrate is then washcoated with the slurry for an upper layer, dried and calcined to form an upper catalyst layer.

On the resulting honeycomb catalyst, the lower catalyst layer is formed in concentration of 160 g per litter of the honeycomb substrate, and the concentration of Pt supported on the honeycomb substrate is 0.5 g per liter. The upper catalyst layer was formed in concentration of 85 g per liter of the honeycomb substrate, and the concentration of Rh supported on the honeycomb substrate is 0.15 g per liter.

A honeycomb catalyst has a catalyst layer with a double-layer structure is prepared in the same manner as in Example 5 except that a Ce(10)/Al₂O₃ powder composed of γ-alumina that contained 10% by mass of Ce was used instead of the Ce(4)/Al₂O₃ powder. The supporting amounts of Pt and Rh are the same as those in Example 5.

Comparative Example 3 is described next. A honeycomb catalyst having a catalyst layer with a double-layer structure was prepared in the same manner as described in Example 5 except that an Al₂O₃ powder composed of γ-alumina that did not contain Ce, which was the same Al₂O₃ powder as in Comparative Example 1 was used instead of the Ce(4)/Al₂O₃ powder. The concentration of Pt and Rh supported are the same as those in Example 5.

Comparative Example 4 is next described. A La(4)/Al₂O₃ powder composed of γ-alumina containing 4% by mass of lanthanum as metallic La was prepared in the same manner as described in Example 1, except that a solution of lanthanum nitrate in ethylene glycol was used instead of the solution of cerium nitrate in ethylene glycol.

A honeycomb catalyst having a catalyst layer with a double-layer structure was prepared in the same manner as in Example 5, except that the La(4)/Al₂O₃ powder was used instead of Ce(4)/Al₂O₃ powder. The supporting amounts of Pt and Rh are the same as those in Example 5.

Comparative Example 5 is next described. A Ba(4)/Al₂O₃ powder composed of γ-alumina containing 4% by mass of barium (Ba) as metallic Ba was prepared in the same manner as described in Example 1, except that a solution of barium acetate in ethylene glycol was used instead of the solution of cerium nitrate in ethylene glycol.

A honeycomb catalyst that includes a catalyst layer with a double-layer structure is prepared in the same manner as described in Example 5, except that the Ba(4)/Al₂O₃ powder is used instead of the Ce(4)/Al₂O₃ powder. The concentration of Pt and Rh supported are the same as those in Example 5.

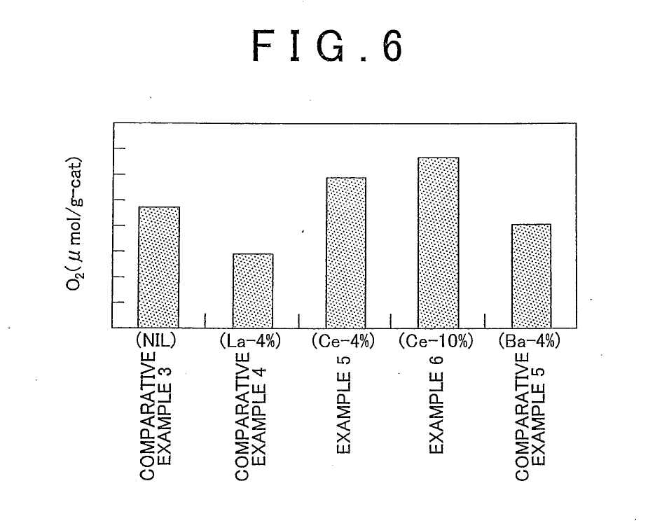

Test Example regarding the oxygen storage capacity is next described. The oxygen storage capacity of each of the honeycomb catalysts of Example 5, Example 6 and Comparative Examples 3 to 5 was measured by using testing machines after an accelerated endurance test was conducted at 1,000° C. for 25 hours by using testing machines. The results are shown in FIG. 6.

From FIG. 6 it is apparent that the honeycomb catalysts of Examples 5 and 6 have a larger oxygen storage capacity after the endurance test than the honeycomb catalysts of Comparative Examples. Because the honeycomb catalysts of the Examples and Comparative Examples have the same upper catalyst layer and because the oxygen storage capacity that is derived from the Ce that is contained in the Ce/alumina in the lower catalyst layer of each example is very small, the increase in the oxygen storage capacity most likely results from an increase in the capacity of the ceria-zirconia composite oxide in the lower catalyst layer.

That is, the oxygen storage capacity only decreases even if the γ-alumina contains La or Ba. In contrast, the oxygen storage capacity increases if the γ-alumina contains Ce. It is believed that the oxygen storage capacity increases because a Pt—O—Ce bond is formed between the Pt and the Ce on the surface of the Ce/alumina and, hence, sintering of Pt during the endurance test is restricted.

The exhaust gas purifying catalyst of the present invention may be used either by itself or as a part of a three-way catalyst or an NOₓ occlusion-reduction catalyst.

1. An exhaust gas purifying catalyst comprising:
a catalyst powder that comprises a ceria-zirconia composite oxide on which at least one of platinum and palladium is supported; and
a Ce/alumina powder that consists of alumina m which cerium is incorporated into the crystalline structure of the alumina, wherein the exhaust gas purifying catalyst is obtained in that the Ce/alumina powder is mixed with the ceria-zirconia composite oxide on which at least one of the platinum and palladium is supported.

2. The exhaust gas purifying catalyst according to claim 1, wherein concentration of the cerium as metallic Ce in the alumina of the Ce/alumina powder is 5 to 10% by mass.
